(19) United States
(12) Patent Application Publication
(10) Pub. No.: US 2010/0101317 A1
(43) Pub. Date: Apr. 29, 2010

(54) LID BASED AMOUNT SENSOR

(75) Inventors: FARHAD ASHRAFZADEH, STEVENSVILLE, MI (US); ALI R. BUENDIA-GARCIA, COLOMA, MI (US); RICHARD A. MCCOY, STEVENSVILLE, MI (US); YINGQIN YUAN, SAINT JOSEPH, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/256,507

(22) Filed: Oct. 23, 2008

(51) Int. Cl. G01F 22/00; G06F 15/00

(52) U.S. Cl. 73/149; 702/188

(57) ABSTRACT

A device for determining the amount of a substance in a container includes an amount sensor disposed within the container, a transmitter coupled to the sensor and configured to transmit an output thereof, and an electrical power source powering the sensor and the transmitter.

### TECHNICAL FIELD

The invention relates to a device including a sensor, capable of being included within a container, for determining the amount of a substance contained therein.

### BACKGROUND

There are numerous containers of various types configured to store all matter of substances. However, determining the amount of the substance stored in the container, which is often useful to know, may be difficult to ascertain. Containers that can self-report the amount of their contents could save significant amounts of manual measuring or guesswork. Additionally, many secondary applications may be available from having a system of containers that self-report the amounts of their contents.

In a kitchen environment, knowing the amount of container contents, such as food, can facilitate more informed food consumption and food purchase decisions. In a household kitchen, particularly when children have access to the kitchen, it may be difficult to regulate or keep track of the removal of food substances from containers. In a commercial kitchen including multiple food preparers rapidly preparing dishes in a stressful environment, the task of tracking the amounts of food substances in numerous containers can be even more challenging.

In a laboratory environment, chemicals, and the like, may require detailed usage tracking. For instance, the substances may be expensive or hazardous. Such usage tracking may require careful removal and measuring of the substance and a recordation of the amount removed in a logbook.

In hospital, pharmaceutical and manufacturing environments and the like, there may also be a need to keep track of the amount of the substance.

Without accurate inventory determinations, maintaining inventory levels may be an ad hoc process. In one approach, inventory trends may be learned over time. However, any identified trends may be upset by unexpected usage. Accordingly, a device to accurately report the amount of a substance stored in a container at any given time may be useful in an inventory system.

### BRIEF SUMMARY

According to an embodiment, a device for determining the amount of a substance in a container includes an amount sensor disposed within the container, a transmitter coupled to the sensor and configured to transmit an output thereof, and an electrical power source powering the sensor and the transmitter.

According to another embodiment, a lid capable of removably closing a container of a substance includes an electrical power source; an identifier associated with the lid; a sensor powered by the power source and capable of measuring a characteristic of the substance in the container and outputting a measurement of the characteristic and a communication device powered by the power source configured to transmit the measurement and the identifier.

According to yet another embodiment, a container includes a body having a cavity capable of containing an amount of substance; an opening into the cavity; and a lid movable relative to the cavity to selectively close the opening. The lid further includes an amount sensor capable of measuring the amount of substance in the cavity; a transmitter coupled to the sensor and configured to transmit an output thereof; and an electrical power source powering the sensor and the transmitter.

The present invention will be more fully understood upon reading the following detailed description in conjunction with the accompanying drawings.

### BRIEF DESCRIPTION OF THE DRAWINGS

In the drawings:

FIG. 1 is a perspective partial view of a kitchen including a refrigerator and cabinets each holding numerous containers.

FIG. 2A is a partially schematic side, cut away view of a container including an exemplary lid based device including an amount sensor.

FIG. 2B is a partially schematic side, cut away, exploded view of the container of FIG. 2A including an exemplary lid based device including an amount sensor showing the lid removed from the container.

FIG. 3 is a partially schematic side, cut away, exploded view of a container including an alternate exemplary lid based device including multiple amount sensors.

FIG. 4 is a partially schematic side, cut away view of an alternative exemplary lid based amount sensor including additional modules.

FIG. 5 is a partially schematic side, cut away view of an exemplary lid based amount sensor included as a removable component.

FIG. 6A is a side, cut away view of another exemplary lid based amount sensor.

FIG. 6B is a perspective view of another exemplary container including a lid based amount sensor showing the lid in its open configuration.

FIG. 6C is a perspective view of the exemplary container of FIG. 6A showing the lid in its closed configuration.

FIG. 7A is a side, cut away view of another exemplary container including a lid based amount sensor attached to a disposable lid.

FIG. 7B is an end view of the lid from FIG. 7A.

FIG. 8A is a perspective view of another exemplary container including magnets disposed about the rim of the opening and a coil based micro-generator disposed on the lid.

FIG. 8B is a side, cut away view of the container of FIG. 8A further depicting exemplary elements of the sensing device included in the lid.

### DETAILED DESCRIPTION

Referring now to the drawings, preferred embodiments of the present invention are shown in detail. Although the drawings represent embodiments of the present invention, the drawings are not necessarily to scale and certain features may be exaggerated to better illustrate and explain the present invention. The embodiments set forth herein are not intended to be exhaustive or otherwise limit the invention to the precise forms disclosed in the following detailed description.

The drawings and the below detailed description relate generally to devices for detecting attributes of substances.

As used herein, a substance is any useful material that can be stored in a container. A consumable substance is a substance that may be stored in varying amounts in containers and may be partially dispensed or removed from the container over a period of time. An attribute of a substance is any information about a substance, including measurable and non-measurable information about the substance that can be stored for later retrieval, including but not limited to its physical or chemical properties, its impact upon its environment, and its amount.

Non-measurable attributes are attributes about the substance that may be stored with the substance or with the container of the substance, whether the attributes would or would not have been measurable by an appropriate sensor. Examples of non-measurable attributes include quantity of consumable pieces, quantity by volume or by weight, date of manufacture, manufacturer, data about its transit from manufacturer, distributor, market, and consumer data about the temperature during transit, nutritional information like calories, fat grams, % daily allowance of essential vitamins and minerals, a list of medical conditions under which a consumable should not be consumed, data about the relationship between the consumable information or data and known diets, known medical conditions, and known reactions to known medications, and the like.

Amount attributes are attributes directly reflecting the amount of the substance available for future use including weight, volume, mass, height, and count. An attribute indicative of the amount is an attribute that may be used or processed to infer or calculate the amount of substance, such as the vapor pressure in a container, the light transmissivity or electrical inductance, capacitance, resistance, reactance, or impedance of the substance. An attribute of the environment is any characteristic of the environment inside of the container, the environment outside of the container, or of the container itself.

As used herein, information or data includes any information, such as genealogical and life cycle information and data about the attributes and data reflecting the attribute values, relating to the substance, the container, the manufacturer, the environment, the user or users, a sensor, an event, a process, a function, a device, a time, a location, an object, a virtual object. Information may be measurable or non-measurable, event based, historical, or identifier information. Information can be values of non-measurable attributes or the identifiers thereof. Information can be values of amount attributes or the identifiers thereof. Information can be stored, received, transmitted, processed, evaluated, or generated. Information that is stored to a machine readable media is herein referred to as stored data.

Since there can be a plurality of containers, each with a substance, there may need to be a unique identifier identifying each container or each substance that may be paired with an attribute measurement of a substance so that the value of the measurement can be uniquely identified per its meaning at a later time and by subsequent intelligent processes. Such identifier may be associated with the substance, the container, the sensor, or the transmitter and such association may occur at the time of creation or assembly of the components, the time of first adding substance to the container, or the time of introducing the container to a system using a plurality of containers. The identifier may also be dynamically generated, for example, from one or more measurable and non-measurable attributes.

Similarly, since there may be a plurality of attributes applicable to a substance, attributes may need to be uniquely identifiable so that when a collection of attributes each having a value is either stored or transmitted, each respective value is paired with its attribute identifier so that the value can be uniquely identified per its meaning at a later time and by a subsequent intelligent process. In the simplest case, where there is only an amount attribute, the system may assume that all values are amount values with an inherent attribute identifier with the meaning of amount.

A container of substance is any container capable of temporarily holding an amount of substance. A lid is a feature of any container which may be opened to permit or improve access to the substance in the container. A dispenser is any feature of a container which permits or drives the active or passive filling of substance into the container or which permits or drives the active dispensing of substance from the container. A main body of a container is any portion of the container which is not a lid or dispenser. A portable container is a container that is intended to be periodically manually moved within a use environment during its lifetime.

A sensor is any active or passive device capable of obtaining information in a form which may be either actively or passively communicated to another device for use by the other device. A communication of information is the delivery of information from a first device to a second device either by the active transmission from the first device to the second device or by the reading of the second device by the first device. A transmitter is any device which wirelessly communicates information to other devices using any form of active or passive transmission including optical or electromagnetic waves.

A triggering event is an event used as an input by a system to begin a process. An access device of a container is any feature of a container that permits access to the substance, including any lid or dispenser. An access event relating to a container of substance is any event indicative of accessing the substance in a container such as an opening, closing, dispensing, dropping, picking up, shaking, transporting, holding, spilling, leaking or re-filling event. Therefore, an access event can be a triggering event if the access event is used as an input by a system to begin a process. A local event, device, process or step is an event, device, process or step existing or occurring in or about the container. A remote event, device, process or step is an event, device, process or step existing or occurring remote from the container. A notification is specific information derived from a system which is a value to a user or to an observing computer program on a remote device. A notification event is an event resulting in the immediate availability of information to a user or the delivery of information to a user, such as audible announcement, a visible display on a user interface, a communication to phone or other portable consumer electronic device, or a notification message either broadcast on at least one computer network or directed to at least one computer containing a software component configured to receive the notification.

Power and energy include any form of power or energy usable by a device for performing an operation and includes electrical, mechanical and chemical power. A power generator is any device capable of generating a usable form of power or energy. A power converter is any device capable of converting one form of power to another such as converting chemical power to electrical power, or converting AC electrical power to DC electrical power.

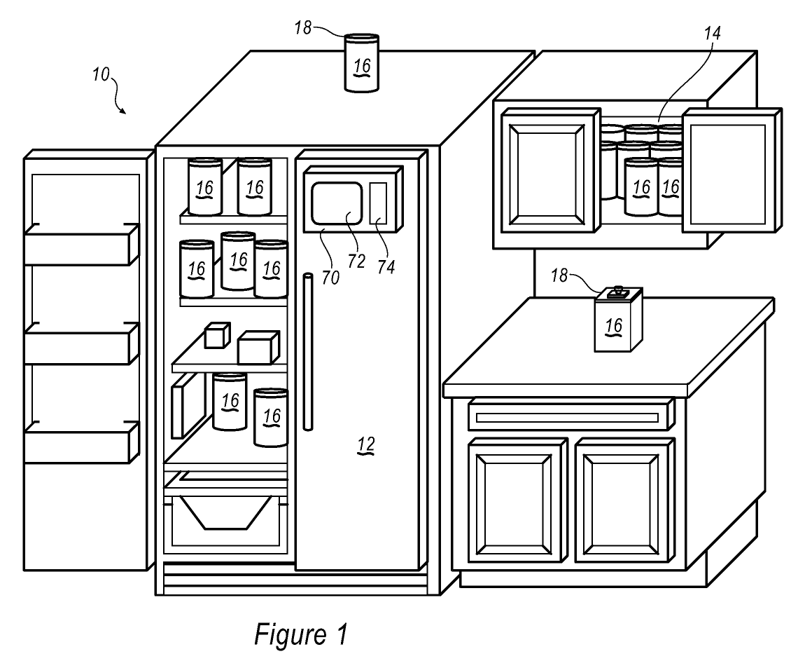

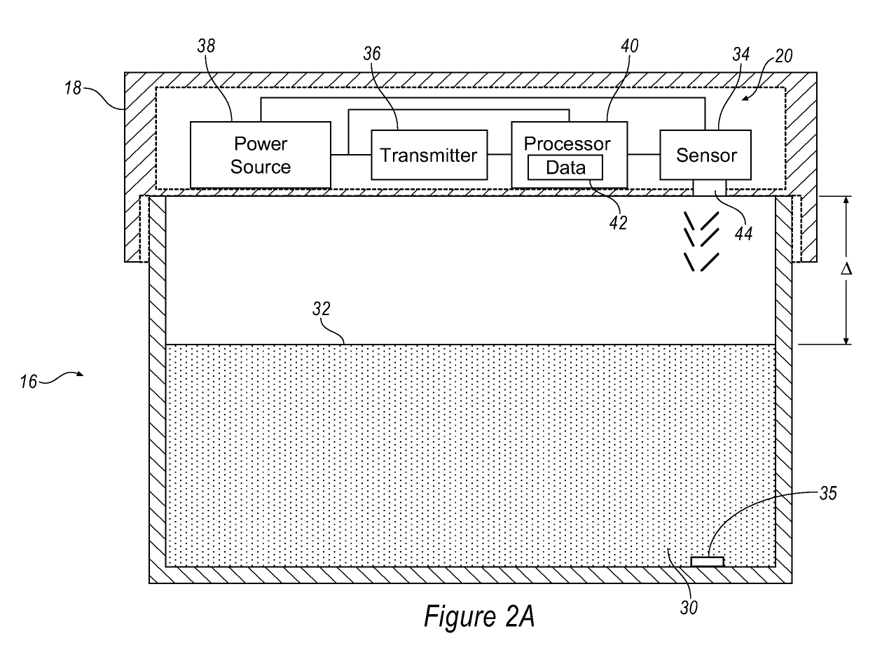

Referring to FIG. 1, a use environment such as a kitchen 10, may include a refrigerator 12 and cabinetry 14 that may each hold a plurality of containers 16. The exemplary kitchen 10 could have additional cupboards and pantries holding additional containers 16. Containers 16 may be enclosed in a storage unit, such as a refrigerator 12 or in the cabinetry 14, or may be in an unconfined location, such as the depiction of a container 16 on top of refrigerator 12. Containers 16 generally include a lid 18 for enclosing a substance 30 being contained. As shown in FIGS. 2A and 2B, the lid 18 may also provide an amount sensing device 20. Sensing device 20 may be configured to determine the amount of substance 30 that is contained in container 16. Moreover, in an environment such as kitchen 10 with multiple containers 16, each container 16 may independently determine the amount of substance 30 contained therein through sensing device 20 disposed in a respective lid 18 of container 16.

In one exemplary approach, sensing device 20 may include a sensor 34, a transmitter 36, a power source 38, a processor 40, and at least one element of stored data 42. Sensor 34, processor 40, and transmitter 36 may be communicatively coupled. In one exemplary approach, sensor 34, processor 40, and transmitter 36 may be separate physical elements coupled by communication wires. However, other exemplary approaches may include one or more of sensor 34, processor 40, transmitter 36, and power source 38 as a single physical element, such as an integrated circuit.

Transmitter and transceiver circuitry has been reduced, for example for RFID tags, to devices as small as a quarter square millimeter (0.25 mm²) and as thin as five hundredths of a millimeter (0.05 mm). Such devices often include a radio-frequency circuit, an antenna, a processor, memory in the form of ROM, a current rectifying circuit and a power and/or synchronizing circuit, not shown in the drawing. For the amount sensing device 30, the processor 40 may be the same processor as is used by the transmitter 36 or may be a separate processor dedicated to the control of the sensor 34, the processing of the output of the sensor, and the communication with the transmitter. The stored data 42 may be ROM memory only or may include some form of writable memory.

Another exemplary approach using an integrated circuit may include Micro-Electro-Mechanical Systems (MEMS). MEMS, sometimes referred to as a system-on-a-chip could include the sensor 34, transmitter 36, power source 38, and processor 40 all on a single silicon chip. Additionally, other sensors 56 and active devices 58, both discussed below, could be included. The circuit based elements may be produced on the silicon chip using a traditional integrated circuit production method while the mechanical components may be produced by a micromachining or etching process. The small scale of a MEMS based device 20 may simplify the association of the device 20 with a container 16 and may reduce the power consumption of the components.

Power source 38 may provide electrical power to sensor 34, processor 40, and transmitter 36 through electrical transmission wires connected thereto.

Sensor 34 may include a sensing element and an output element to output a reading of the sensing element. In one exemplary approach, output element may simply be the communication wires connecting sensor 34 to processor 40 and transmitter 36. However, in other exemplary approaches, output element may format or adapt the reading of sensing element prior to output. For instance, the output of sensing element may require analog to digital conversion which may be provided by an analog to digital converter of output element.

Sensing element of sensor 34 may be configured to sense the distance (Δ) between sensor 34 and a level 32 of substance 30. Sensor 34 of sensing device 20 may be attached to container 16 at a fixed reference point to provide consistent measurements of distance Δ. In one exemplary approach, the reference point may be associated with lid 18. The reference point may represent the uppermost limit of level 32 such as a fill line of container 16. The amount of substance 30 may be determined based on distance Δ in relation to the physical shape of container 16.

Sensor 34 may utilize any of a number of sensing techniques. In one exemplary approach, sensor 34 employs an acoustic sensing technique. The acoustic sensing technique may include an ultrasonic generator, an ultrasonic receiver, a timer, and a processor. An ultrasonic pulse or plurality of pulses may be generated and directed at substance 30. The pulse may reflect off the surface 32 of substance 30 and be collected by the receiver. The timer may record the time between the generation and reception of the pulse. Distance Δ may be calculated based on the recorded time with respect to the speed of sound.

In another exemplary approach, sensor 34 may employ a capacitance sensing technique. The capacitance sensing technique provides a first capacitance plate and an electrical charge sensing element. Surface level 32 of substance 30 acts as a second capacitance plate. The first plate is charged to create an electrostatic field. The field is affected by distance Δ to surface level 32 in a manner that may be perceived by the sensing element. The sensed difference in the field may be used with a calculation or look-up table to determined distance Δ.

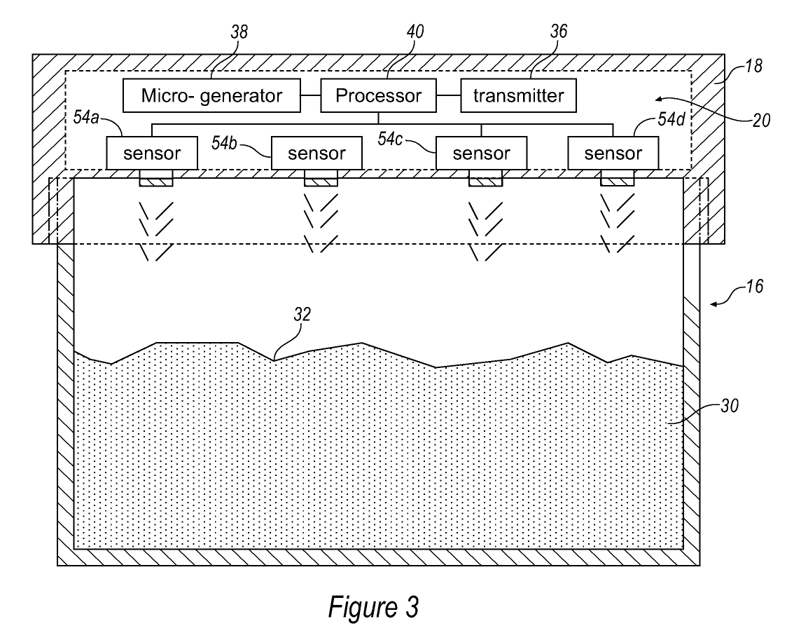

In yet another exemplary approach, sensor 34 may employ an infrared (IR) sensing technique. The IR sensing technique may include an IR light source, an IR receiver, and a sensing element. Beams of IR light may be distributed from the light source at an angle. The beams reflected off of surface level 32 may be received by the IR receiver. Triangulation calculations may be used to determine distance Δ. Infrared sensing may require two sensors 54, 56 such as the depiction in FIG. 4.

In still another exemplary approach, sensor 34 may emit an electromagnetic signal, such as infrared, ultraviolet or a visible light signal which is directed through the substance to a sensing target disposed within the container wherein the amount sensor can determine information associated with the amount of a substance in response to information associated with the sensing target. For example, signal from the sensor 34 may be reflected off a surface, such as a reflector 35, and returned to the sensor. The sensor can receive the reflected signal and determine amount or other attributes of the substance by the affect of the substance on the reflected signal.

It is to be understood that the list of sensing technologies listed above is not an exhaustive list. Additional sensing technologies may also be suitable, e.g., inductive sensing, resistive sensing, evaporative gas sensing, image sensing, pressure sensing, float sensing or other mechanical sensing, strain gauge or force sensing, etc. An inductive sensor may pass a current through an inductive loop creating a magnetic field. A metal substance 30 in the presence of the magnetic field produced by the loop may effect the inductance of the loop. The change in inductance may be sensed by the inductive sensor to determine the proximity of the substance 30 to the sensor 54. A strain gauge sensor may measure deformation or strain of the container 16 cause by the substance 30. A foil pattern may be deformed by the strain thereby altering its resistive properties. The change in resistance may be measured and used to determine an indication of the amount of the substance 30. A float sensor may be used with a liquid substance 30. A float may ride against a vertically disposed set of contacts. The float may therefore complete a circuit at a set of contacts corresponding to the surface level 32 of the substance 30. A pressure or force based sensor such as a scale may be used to determine the weight of the substance 30. The weight may be used along with a known density of the substance in order to determine an indication of the amount of the substance 30.

An evaporative gas sensor may sense the concentration of the substance 30 that has evaporated into the air within the container. The concentration may vary based on the amount of the substance 30 in the container 16 and therefore may be used to determine an indication of the amount. Optical sensing may use a set of vertically arranged image sensors. The level 32 of the substance 30 may be determined based on the height of the last sensor to be obstructed by the substance 30. An image sensor may be used with a transparent container 16 in order to capture an image of the substance 30 including the surface level 32. An image processing device may use the image to determine an indication of the amount based on the surface level 32.

An aperture 44 may be provided in lid 18 to facilitate operation of sensor 34. In another exemplary approach, aperture 44 may be covered with a protective element 60. Protective element 60 may further be a lens for an IR or optical based sensor 34.

Accordingly, while sensor 34 may be provided by numerous sensing technologies, any particular sensor 34 may determine distance Δ. In one exemplary approach, sensor 34 may output distance Δ to transmitter 36. In such an approach, a control unit 70, discussed below, may receive the transmitted distance Δ and calculate the amount of substance 30 based on distance Δ. In another exemplary approach, sensor 34 may output distance Δ to processor 40. In such an approach, processor 40 may calculate the amount of substance 30 based on distance Δ. Accordingly, transmitter 36 may transmit the amount of substance 30 in container 16 rather than distance Δ.

Transmitter 36 may transmit information about container 16 by interfacing with a receiver 70, discussed below. Transmitter 36 may communicate wirelessly with receiver to transmit the information about container 16. The specific types of information that may be communicated will be addressed below. In one exemplary approach, the communication between transmitter and receiver is unidirectional with all transmissions originating from transmitter 36. However, other exemplary approaches may include a receiver with device 20 for implementing bi-directional communication. Transmitter 36 may include any of a number of transmitting technologies. Transmitter 36 may be a transceiver in that it may include a receiver to receive communications from other components, e.g., control unit 70. Communications received by the receiver may provide instructions to the processor 40, such as an instruction to activate the device 20 to determine the amount of the substance 30. Similarly, communications may include the reading of or the writing of stored data 42, discussed below, for use by the device 20.

In one exemplary approach, transmitter 36 may be a radio frequency (RF) transmitter. RF transmitters emit signals in the radio frequency range of the electromagnetic spectrum. Within the domain of RF transmitters, any of a number of RF transmission standards may be employed by transmitter 36. The RF transmission standard generally defines the signal strength, frequency, data throughput, and communications protocol. Low power RF standards, such as Bluetooth®, Zigbee®, Wibree™, enOcean®, Z-wave®, etc., are ideally suited for sensing device 20. In other exemplary approaches requiring greater data rates or transmission range, a radio frequency transmitter operating according to the wi-fi or wi-max transmission standards may be employed.

In yet another exemplary approach, transmitter 36 may be a radio frequency identification (RFID) circuit. In such an approach, an RFID circuit may act as both transmitter 36 and power source 38. The RFID circuit may include an antenna for transmitting RF signals. The antenna may also inductively generate electrical power when in the presence of an operating RFID reader.

In another exemplary approach, transmitter 36 may be an IR transmitter. The IR transmitter may include an IR diode that can produce an IR signal. The IR signal may then be received by a photoelectric receiver included with receiver 70. In another exemplary approach, transmitter 36 may produce a visible light signal. A visible light signal may produce a series of light pulses that may be received and interpreted by a receiver. Both an IR transmitter and a visible light transmitter typically rely on line of sight and therefore may be suited toward an implementation where line of sight communication is available or necessary.

In another exemplary approach, transmitter 36 may be an acoustic transmitter. For instance, transmitter 36 may be a speaker configured to audibly transmit the output of sensor 34. Transmitter 36 may announce the amount of substance 30 contained in container 16. Other acoustic transmitters may emit signals in an inaudible frequency for receipt and interpretation by an acoustic receiver.

While not depicted in the drawing figures, transmitter 36 may require an aperture in outer portion of lid 18. For instance, a non-metal aperture in a metal lid 18 may facilitate the transmission of radio frequency signals. Similarly, an IR transmitter may require a transparent or translucent aperture for the passage of the infrared signals and may further include a lens with the aperture. It will also be appreciated that transmitter 36 may be provided on the outer surface of lid 18.

Power source 38 may provide electrical power to transmitter 36, sensor 34, and processor 40. The environment of kitchen 10 generally cannot accommodate a plurality of containers 16 wired to a power source 38. Accordingly, power source 38 may be a wireless power source allowing sensing device 20 to be self-contained and in some exemplary approaches, self-sufficient. Moreover, any of a number of wireless power sources may be employed as power source 38. Some examples of wireless power sources include a battery, a solar cell, a fuel cell, an RFID circuit, as well as energy harvesting techniques. Batteries, such as dry cell batteries, are well known for providing power to devices that cannot accommodate being wired to a power source. Dry cell batteries typically use a chemical reaction to provide power. As a result, batteries may become depleted over time. Accordingly a device with a battery power source may need to allow for replacement of the battery or may need to be disposable. A battery based power source may be implemented when the device 20 needs to be activated at arbitrary times as well as when the device 20 needs to be continuously activated. A battery may further act as a supplemental power source to other power sources discussed below. Solar cells, or photovoltaic cells, are known for implementing the photovoltaic effect to convert light energy into electrical energy. A cell disposed on an outer portion of the lid 18 could absorb light from the environment when removed from a containing unit 12. Solar and RFID based power sources are discussed in further detail below.

Energy harvesting techniques may include an inductive generator, a piezoelectric generator, a thermoelectric generator, a kinetic micro-generator a electrochemical generator and combinations thereof. Energy may be harvested, for example, from motion, forces, temperature gradients, ambient sources or a combination thereof.

An inductive generator may generate power from the movement of the lid. A source of magnetic flux may be associated with one of the lid and the jar, and a flux responsive device may be associated with the other of the lid and the jar. As described later herein in greater detail, the source of magnetic flux may be one or more permanent magnets attached to a surface of container 16, such as the rim of container 16. The flux responsive device may be a conductive coil extended along a circumferential surface of the lid, such as a lip portion of lid 18 that overlaps the rim of container 16. Spinning lid 18, which may be necessary to unscrew a screw-on lid, passes the coil through the magnetic fields provided by the magnets, which in turn induces a voltage between the ends of the coils.

A piezoelectric generator employs a material that demonstrates a piezoelectric effect. Applying a force or strain to the piezoelectric material may produce electrical energy that can be used by the elements of sensing device 20.

A thermoelectric generator may rely on a temperature gradient between two conducting materials to produce electrical energy.

Kinetic micro-generators may employ a moving element such as a pendulum, piston, flywheel, etc. to charge a capacitor which may in turn provide an electrical output. The moving element may cause an attached magnet to oscillate in the presence of a coil, which in turn charges the capacitor. The capacitor may then be discharged at the time the device 20 needs to be powered. A kinetic micro-generator may use piezoelectrics to harvest energy from ambient mechanical vibration.

A kinetic micro-generator may convert ambient vibration into electricity by placing magnets along a beam that is configured to vibrate in response to the ambient vibration. As the beam vibrates, the magnets move in response and move relative to a coil in proximity to the beam and the magnets. As the magnets move relative to the coil, electro-magnetic induction causes current to flow in the coil. The current flow is the electric energy.

Solar cells and kinetic micro-generators are examples of power sources that derive their power from the natural ambient environment.

Power source 38 may provide power in response to accessing the substance of the container 16. Moreover, the time that container 16 is accessed is an ideal time to power sensing device 20 to determine the amount of substance 30 because container 16 is generally accessed for the purpose of removing a portion of substance 30. Therefore, sensing device 20 may be able to not only determine the amount of substance 30, but also may be able to calculate the portion of substance 30 removed with each access to container 16. However, if the activation of the device 20 is based on power generated from a movement there may be multiple sensor readings associated with an access of the container. Moving the container 16 may cause a reading while in transit. Removing the lid 18 may cause another reading, and affixing the lid may cause yet another reading. It may be desirable to take a reading both before and after an opening to determine the amount of the substance 30 removed or added. However, the difference between general movement, opening, and closing may need to be differentiated. Additionally, a delay in the activation of the device may allow for the substance 30 to settle prior to determining the amount. An energy storage unit, such as a capacitor coupled with other elements, may be included with power source 38 in order to store the electrical energy until it is needed. Processor 40 may initiate the process such as through the generation or release of energy after the delay.

The choice of power source 38 may affect the specific time that sensing device 20 determines the amount of substance 30. For instance, a solar cell based power source may generate electrical power when container 16 is removed from an enclosed area such as refrigerator 12 or cabinetry 14 and exposed to a light source. A piezoelectric generator may generate electrical power as a result of the force or strain placed on lid 18 during its movement, such as by the removal of the lid. An RFID circuit may generate electrical power when exposed to an RFID reader. A thermoelectric generator may generate electrical power due to the temperature differential created when a container 16 is removed from refrigerator 12. While the power sources 38 just discussed may be able to automatically generate electrical power during the opening or closing of container 16, a battery based power source 38 may require the inclusion of an additional element in sensing device 20 such as a switch or an accelerometer in order to sense the opening or closing of container 16.

Processor 40 of sensing device 20 may be a general purpose microprocessor. Such a processor may provide a predefined instruction set that can be used to program device 20 with very flexible control software. However, in another exemplary approach, processor 40 may merely include circuitry to allow the level reading of sensor 34 to be transmitted by transmitter 36.

Processor 40 may include stored data 42. In one exemplary approach stored data 42 may be permanently embedded in processor 40. For instance stored data 42 may include a data element that is an identifier. The identifier may identify the device 20, the container 16, the substance 30, or a class of the substance 30. Moreover, in an environment 10 including a plurality of containers 16, the identifier may uniquely identify a particular device 20. In another exemplary approach, stored data 42 may be dynamically modifiable. Processor 40 may include a memory storage device such as flash memory, an EEPROM, etc., which holds stored data 42. Sensing device 20 may additionally include a receiver to receive new data for use as stored data 42.

Stored data 42 is not limited to being only an identifier and may include many other possible items. Stored data 42 may include an indication of a prior amount of the substance 30. The prior amount compared to the current amount may allow for a determination of a portion of the substance 30 that has been removed. Stored data 42 may provide an indication of a chemical component of the substance 30. For instance, it may be desirable to know the chemical composition of the substance to make decisions regarding the environmental conditions of the substance 30, among other reasons.

Stored data 42 may include date and time values such as a date and time that the container 16 was first opened, a date and time that the container 16 was last opened, a date and time that the substance was processed or packaged at a processing facility. Stored data 42 may include manufacturing or processing information such as a name of the producer of the substance 30, a trade name of the substance 30, a generic name of the substance 30, an identifier of the processing facility that processed the substance 30, a batch number of the substance 30. Stored data 42 may include nutritional and health information such as an indication of the nutritional attributes of the substance 30, an indication of the presence of allergens associated with the substance 30, and an indication of a dosage of the substance 30.

Stored data 42 may provide information for use in the determination of the amount of the substance 30 such as a lookup table mapping the output of the sensor 34 to the amount of the substance 30, or an indication of the physical dimensions of the container 16. Stored data 42 may be used to regulate and track the usage of the substance 30 by providing a history of the amounts of the substance 30 as well as an indication of a permitted user of the substance 30. As will be discussed in more detail below, sensing device 20 may include additional sensors and accessory modules. Accordingly, stored data 42 may provide an indication of an ideal environmental condition of the substance 30, an output from an additional sensor, as well as a control parameter for an accessory module. Stored data 42 may further hold information from external sources such as sensors in the containing unit 12 or even information from other containers 16.

A control unit 70 may be provided in kitchen 10 for communicating with sensing devices 20. Control unit 70 may be integrated with an appliance as depicted, or may be a stand alone device. Similarly, control unit 70 may be provided as a peripheral of a PC or notebook computer. Control unit 70 may include a receiver and transmitter, not shown, for receiving communications from transmitter 36 of sensing device 20. The receiver of control unit 70 generally includes the same transmission technology as transmitter 36. However, if kitchen 10 includes sensing devices 20 with multiple transmission technologies, including any of those discussed above, control unit may provide multiple receivers each configured to receive a respective type of transmission. In an approach using RFID circuits in sensing device 20, control unit 70 may provide an RFID reader for both activating and communicating with the RFID circuit.

Control unit 70 may provide a visual display 72 and a control interface 74 such as a key pad. In another exemplary embodiment, display 72 and control interface 74 may be integrated. Display 72 and control interface 74 cooperate to provide a user with facilities to control and interact with control unit 70 and sensing devices 20. Interface 74 may display the amount of substance 30 in container 16. In addition, Control unit 70 with Display 72 and control interface 74 may function as user interface for refrigerator 12 or any other appliance like cooktops, ranges, dishwashers, washers, dryers, and the like, allowing the Control Unit 70 to send command that effect the cycle of operation of the appliance. Interface 74 may display the amount of substance 30 in container 16 or cycle information about the cycle of operation of the appliance. Moreover, in a kitchen 10 with multiple containers 16, display 72 may show the amounts of substance 30 for each container. As discussed above, stored data 42 may include an identifier to assist the control unit 70 and the user in determining the amount of substance 30 associated with a particular container 16. Control unit 70 may allow a user to associate an identifier with a particular substance. For instance, if container 16 may be refilled with multiple different substances 30, control unit 70 may allow the user to associate a name or label with an identifier.

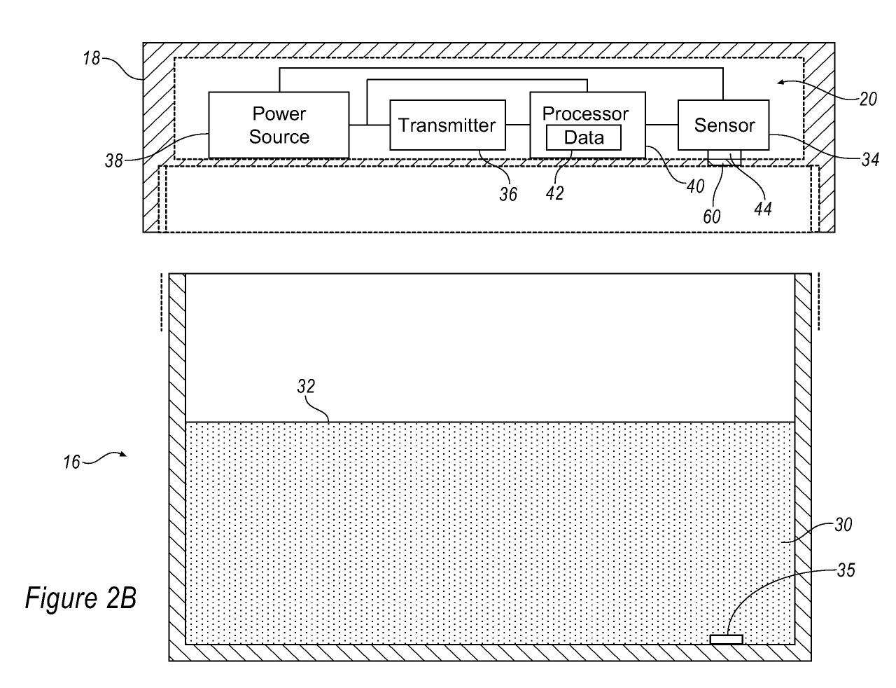

FIG. 3 illustrates another exemplary container 16 having an amount sensing device 20 associated with the lid 18. As with the exemplary sensing devices discussed above, the device 20 of FIG. 3 includes a processor 40 and transmitter 36. The device 20 may be powered by a power source that may be a micro-generator 38, discussed below. Device 20 includes a plurality of amount sensors 54a-d. Each sensor 54a-d is distributed to different sections of the lid 18. Accordingly, each sensor 54a-d will read an indication of the amount of the substance 30 stored in the container at different points. Such an approach may be suited to determine the amount of substance 30 having an irregular surface level 32. The distance Δ between the surface level 32 and each sensor 54a-d may be different. A single distance Δ may be determined to a calculation, such as an average, of each reading of sensors 54a-d.

FIG. 4 illustrates another exemplary sensing device 20 having an additional sensor 56 and accessory modules such as an active device 58, a clock 62, and a user authorization module 64. As discussed above the additional sensor 56 may be a second sensor used to determine the amount of substance 30 in container 16. However, in another exemplary approach, the additional sensor 56 may be unrelated to the determination of the amount of substance 30. For instance, the additional sensor 56 may sense container attributes for determining the freshness or quality of substance 30. The active device 58 is one example of an accessory module that may be included with sensing device 20. Active device 58 may operate to affect the substance. Active device 58 may include a motor, an agitator, a fan, a dispenser, a dryer, a pump, a cooler, a heater, an ozone generator, a GPS device, etc. The active device may further affect the environment inside the container 16 above the surface level 32 of the substance 30. For instance, a pump may pressurize or depressurize the environment. A dryer may remove humidity from the environment. A fan or agitator may simply stir the air to create a circulation pattern. An ozone generator may produce ozone that can have preservative effects on certain kinds of substances 30, e.g., foodstuffs. A dispenser may emit substances necessary or useful to the substance 30, e.g., a preservative, etc. A GPS device may be used to provide positional information about the substance or container either in a global geographic context or in a local context within the use environment.

Clock 62 may allow for the determination of the access times of container 16. The access times may be used to generate a usage history. Access times may also be used in cooperation with other date values such as the processing or production date of substance 30 in order to determine the freshness or quality of substance 30. Clock 62 may further allow the tracking of the amount of time that lid 18 is removed from container 16. Such information may further be useful in determining the freshness or quality of substance 30. User authorization module 64 may associate an individual to an access of container 16 and also to the removal of substance 30 from container 16. User authorization module 64 may provide an interface on an external surface of lid 18, e.g., a key pad, for accepting a user identification number. However, in another exemplary approach, sensing device 20 may further include a receiver, not shown, for bi-directional communication with control unit 70. A user may key in an identification number into the control interface 74 which would then be transmitted to sensing device 20.

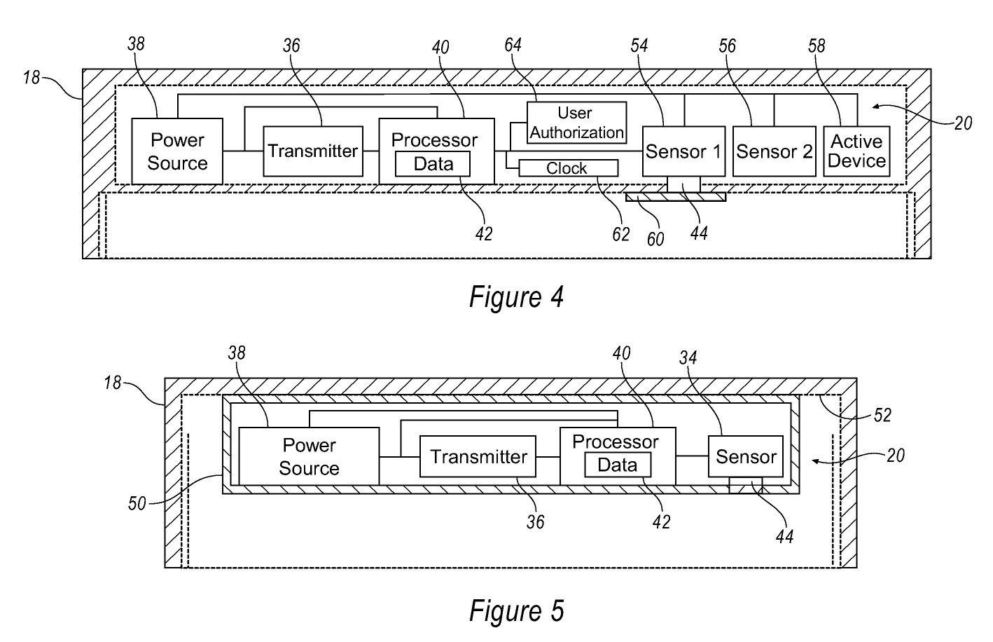

FIG. 5 illustrates another exemplary sensing device 20. Some containers 16 may be manufactured without sensing device 20 integrated into lid 18. Moreover, a user may not want to have sensing device 20 in every container 16. Accordingly, common enclosure 50 may house the elements of sensing device 20 such as sensor 34, transmitter 36, power source 38, and processor 40. While common enclosure 50 could be fixedly attached to an inner surface 52 of lid 18, common enclosure 50 may allow sensing device 20 to be removably attached to inner surface 52. A removably attachable common enclosure 50 may allow sensing device 20 to be used in association with more than one container 16. Additionally, certain environments, e.g., a microwave, a dishwasher, may be harmful to the device. Accordingly, the common enclosure 50 may facilitate the removal of the device 20 at times when the container 16 will be subjected to harsh environments.

When transferring device 20 with common enclosure 50 to a different container 16, it may be desirable to associate an element of the stored data 42, such as an identifier, with the new container 16 or substance 30. Control unit 70 may control the association of identifiers to particular containers 16 or substances 30. For instance, control unit 70 may provide an interface in cooperation with display 72 and control interface 74 for identifying substance 30, container 16, etc., and associating those with an element of the stored data 42 when transferring sensing device 20 to a different container 16. Similarly, sensing devices 20 may be produced in bulk and packed as a dispensable roll of devices 20. Such an approach may be suited to a container 16 production or processing facility. Some elements of the stored data 42 may be set for the sensing device 20 at the time of associating lid 18 with container 16, at the time of associating sensing device 20 with lid 18, at the time of filling of container 16, at the time of sale of the container 16, at the time of introduction of container 16 into inventory, at the time of introduction of container 16 into a use environment, or at the time of first use of the contents of container 16.

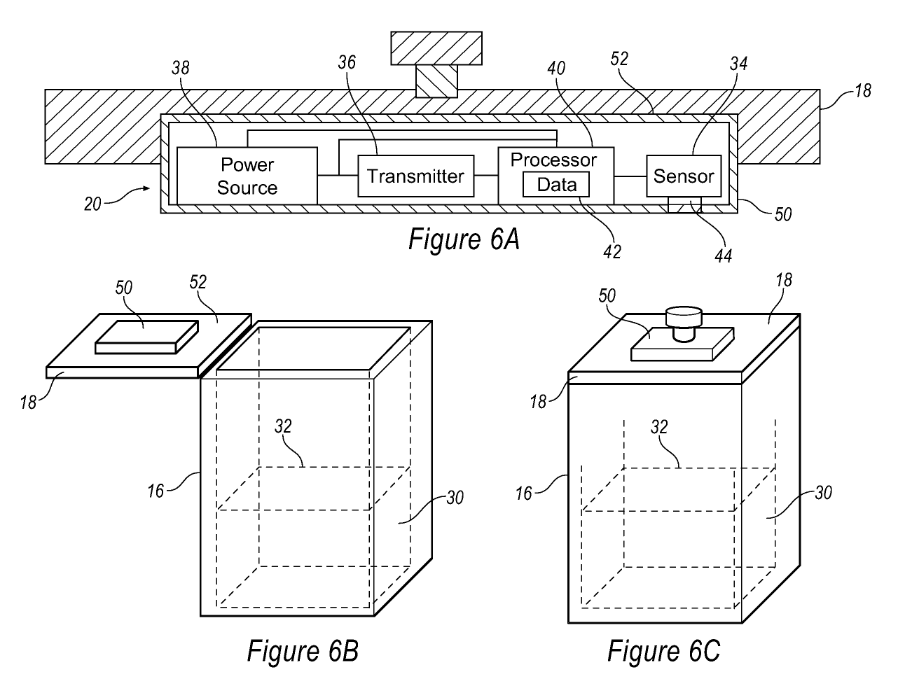

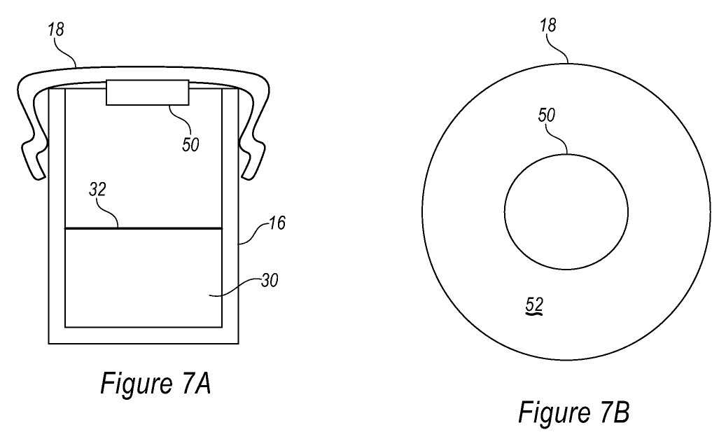

FIGS. 6A-6C and 7A-7B illustrate other exemplary containers 16.

In FIGS. 6A-6C, sensing device 20 housed in common enclosure 50 may be fixedly or removably attached to inner surface 52 of lid 18. A container 16 with a square cross section, i.e., container 16 of FIG. 6A-6C, may require stored data 42 to include different information related to the physical characteristics and shape in order for sensing device 20 to accurately determine the amount of substance 30 being contained. Moreover, a removably attachable sensing device 20 may need to have some of its stored data 42 updated with any container characteristics required by processor 40 in determining the amount of substance 30 contained in container 16.

FIGS. 7A-7B depict yet another exemplary container 16. Lid 18 may be a disposable lid such as a sheet of plastic wrap or metal foil disposed about the opening of container 16. A removably attachable sensing device 20, housed in common enclosure 50, may be attached to the inner surface 52 of the disposable lid 18. However, the device 20 does not necessarily need to be detachable. For instance, a manufacturer of disposable covering may embed disposable devices 20 with the covering. Accordingly, a sheet of disposable wrap or covering may already include one or more devices 20. At the time the disposable covering is applied to the container 16, the sensing device 20 may be associated with the container 16 and contents 30 as discussed above.

Control unit 70 may be configured to simultaneously interact with sensing devices 50 disposed in a plurality of container shapes, such as those depicted in FIGS. 2 and 7A. For instance, sensing devices 20 may be disposed in the three types of the depicted container 16 embodiments within the same kitchen 10. Control unit may receive the amounts of substance 30 container in each container 16 regardless of the diversity of container shapes and configurations.

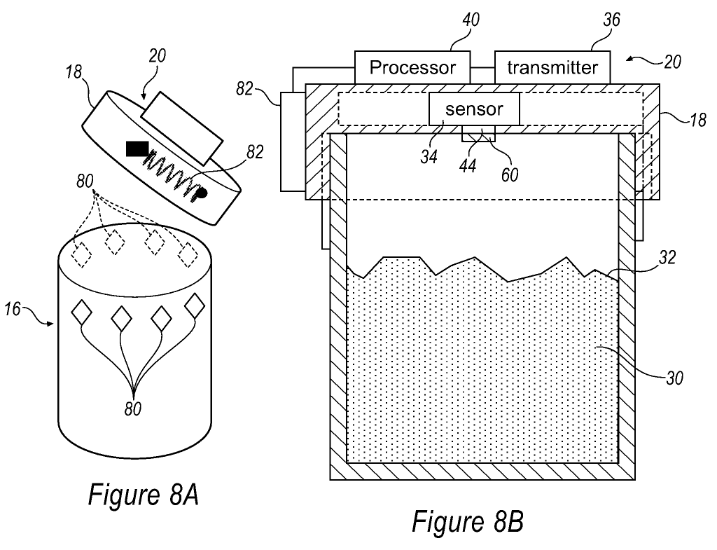

FIGS. 8A and 8B depict another exemplary container 16 including an amount sensing device associated with the lid 18. The container 16 of FIGS. 8A and 8B includes a micro-generating power source that includes a source of magnetic flux a plurality of magnets 80 and a flux responsive device such as a coil 82. The configuration of the coil 82 and magnets 80 disposed about lid 18 may generate electrical energy when opening or closing container 16. For instance, the plurality of magnets 80 could be disposed about the rim of container 18. The coil 82 may then be provided in a lip portion of lid 18 that overlaps the rim of container 18. Spinning lid 18, which may be necessary to unscrew a screw-on lid 18, passes the coil 82 through the magnetic fields provided by the magnets 80, which in turn induces a voltage between the ends of the coils. A diode blocking current in one direction may allow for the activation of the device only during a closing or opening event rather than during both. This may allow for consistent sensor readings, i.e. only during the closing of the container. The magnets 80 may be removable from container 16 in order to be used with another container 16. For instance, the magnets 80 may be provided in a tape with an adhesive backing to facilitate the installation on the container 16.

In the example illustrated, the magnets are on the main body of the container and the coil is on the lid 18 so that power is available on the lid. The magnet and coil structure disclosed may be reversed, however, for other uses where it is desired to have power available on the main body of the container.

Other embodiments of self-reporting containers 16, additional related components, features and methods are described in the following related applications filed concurrently herewith: U.S. Patent Application entitled “MODULAR ATTRIBUTE SENSING DEVICE,” bearing applicant's docket number US20080686, U.S. Patent Application entitled “METHOD OF INVENTORY MANAGEMENT,” bearing applicant's docket number US20070823, U.S. Patent Application entitled “ATTRIBUTE SENSING PROCESSES,” bearing applicant's docket number US20070824, U.S. Patent Application entitled “SYSTEM AND METHOD FOR TRACKING INVENTORY HISTORY,” bearing applicant's docket number US20080477, U.S. Patent Application entitled “INVENTORY COMPONENT ACTIVATION,” bearing applicant's docket number US20080478, U.S. Patent Application entitled “CONSUMABLES INVENTORY MANAGEMENT METHOD,” bearing applicant's docket number US20080479, U.S. Patent Application entitled “INTRODUCTION OF A SELF-REPORTING PORTABLE CONTAINER INTO AN INVENTORY SYSTEM,” bearing applicant's docket number US20080684, and U.S. Patent Application entitled “INTRODUCTION AND ACTIVATION OF A SELF-REPORTING PORTABLE CONTAINER INTO AN INVENTORY SYSTEM,” bearing applicant's docket number US20080685, each of which is incorporated herein by reference in its entirety.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims.

For example, the examples illustrated use a lid opening as an access event to generate power for the sensor and the transmitter. It is contemplated that for some applications, there is a dispenser mechanism that is used for accessing the substance in a container and the access event triggering the operation of the sensor is the operation of the dispenser. It is contemplated that for other applications, the access event will trigger operation of the sensor or the transmitter, such as by use of an accelerometer, but will not provide power to the sensor or the transmitter, which may either be powered by another device such as a battery or may be unpowered.

Furthermore, while the containers illustrated and described above are passive storage containers, it is contemplated that in some applications, the containers may be storing a substance while an operation is being performed on the container and/or substance, such as heating, cooling or mixing, shaking by an external device such as a stove, and oven, or a mixer. Thus, for example, the container may be a pot, a baking dish, or a mixing bowl having a lid or dispenser with a sensing system of one of the types described above. The sensor system may be used to monitor or control the cooking operation, such as to determine when an operation is complete or when some attribute has exceeded some pre-set limit.

Additionally, the sensor system may detect an undesired access or dispensing event which may be indicative of an undesired condition, such as leakage from a container, boil-over, boil dry, evaporation or unexpected access.

It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A system for determining the amount of a consumable substance in a portable container, comprising:
an amount sensor disposed at least partially within the container; and
a transmitter coupled to the sensor and configured to transmit an output thereof.

2. The system according to claim 1, wherein the amount sensor is one of an acoustical sensor, an optical sensor, a capacitive sensor, an inductive sensor, a resistive sensor, an evaporative gas sensor, an image sensor, a pressure sensor, a float sensor, an infrared sensor, a strain gauge sensor, a distance sensor, and a force sensor.

3. The system according to claim 1, further comprising a data storage medium and at least one element of stored data contained therein; and wherein, the transmitter is further configured to transmit the at least one element of stored data with the output.

4. The system according to claim 3, wherein the at least one element of stored data includes an identifier.

5. The system according to claim 4, wherein the identifier is unique to one of the device, the container, the substance, and a class of the substance.

6. The system according to claim 3, wherein the at least one element of stored data includes one of:
an indication of a prior amount of the substance;
an indication of a chemical component of the substance;
a time that the container was first opened by a user;
a time that the container was last opened;
a time that the container was first filled with substance;
a name of the producer of the contents;
a trade name of the substance;
a generic name of the substance;
an identifier of the processing facility that processed the substance;
a batch number of the substance;
a processing date of the substance;
an indication of the nutritional attributes of the substance;
an indication of the presence of allergens associated with the substance;
a lookup table mapping the output of the sensor to the amount of the substance;
an indication of the physical dimensions of the container;
a history of the amounts of the substance;
a control parameter for an accessory module;
an indication of a dosage of the substance;
an indication of an ideal environmental condition of the substance;
information about a physical characteristic of the substance;
an indication of a permitted user of the substance; and
an output from an additional sensor.

7. The system according to claim 1, for a container having a main body and a lid wherein at least one component is configured for being disposed on an inner surface of a lid of the container.

8. The system according to claim 7, wherein the at least one component comprises at least a component of at least one of the amount sensor and the transmitter.

9. The system of claim 1 further comprised by at least one sensing target disposed within the container wherein the amount sensor can determine information associated with the amount of a substance in response to information associated with the sensing target.

10. The system of claim 9 further comprised by at least one sensing target disposed within the container wherein the amount sensor can determine information associated with the amount of a substance in response to sensing information associated with the sensing target.

11. The system according to claim 1, further comprising a data storage medium and at least one element of stored data contained therein; and wherein the transmitter is further configured to transmit the at least one element of stored data with the output.

12. The system according to claim 1, wherein the amount sensor comprises a level sensor capable of measuring an indicator of the height of the substance in the container.

13. The system according to claim 12, wherein the level sensor is disposed at a reference point, and is capable of measuring the distance between the reference point and a surface of the contents of the container.

14. The system according to claim 1, wherein the amount sensor comprises a plurality of level sensors each capable of measuring an indicator of the height of the substance in the container at a different location in the container.

15. The system according to claim 1, further comprising a second sensor coupled to the transmitter, and wherein the transmitter is configured to transmit an output of the second sensor.

16. The system according to claim 15, wherein the second sensor senses at least one of temperature, color changes, odor, texture, density, consistency, variability of color or texture, imaging, pH, viscosity, and the presence of specific gases further comprises an active device coupled to the generator to selectively act upon the contents of the container.

17. The system according to claim 1, further comprising an active device coupled to the electrical power source and capable of acting upon the contents of the container.

18. The system according to claim 17, wherein the active device comprises at least one of a heater, a cooler, a mixer, a dryer, a chemical dispenser, a fan, a dehumidifier, and ozonator, a pump, a GPS device, and a carbonator.

19. The system according to claim 1, further comprising a data storage medium containing at least one characteristic of the container and a processor coupled to the data storage medium and to the sensor and configured to receive an output of the sensor and for determining the amount of substance based on the output and the at least one characteristic.

20. The system according to claim 19 wherein the transmitter is coupled to the processor and configured to transmit the amount of substance determined by the processor.

21. The system according to claim 1, further comprising at least one of:
a power source powering sensor and the transmitter;
a common enclosure for the sensor, transmitter, and power source, wherein the common enclosure is removably attached to the container;
a second sensor comprising at least one of a sensor, a gas sensor, a temp sensor, an image sensor, a chemical sensor, a light sensor, a pressure sensor,
a clock;
a user authorization device;
a user authentication device;
a unidirectional permeable membrane protecting the device from the contents of the container; and
a data storage medium containing at least one characteristic of the container and coupled to the transmitter, the transmitter being configured to transmit the at least one characteristic.

22. The system according to claim 21, wherein the amount sensor senses at least one of weight, volume, mass, height, and count.

23. The system according to claim 21, further comprising a lid removably closing the container, the amount sensor and the transmitter being coupled to the lid.

24. The system according to claim 1, wherein the output is associated with an unexpected amount in response to the amount sensor detecting the amount of a substance within the portable container.

25. The system according to claim 24, wherein the unexpected amount represents detection of the leakage of a substance.

26. A system for determining the amount of a substance in a container, comprising:
an amount sensor disposed at least partially within the container; and
a power source powering at least one of the sensor and the transmitter.

27. The system according to claim 26, wherein the power source derives its power from the natural ambient environment.

28. The system of claim 27, wherein the power source is one of a battery, a fuel cell, a solar cell, an RFID circuit, an inductive generator, a piezoelectric generator, a thermoelectric generator, and a kinetic micro generator.

29. The system of claim 26 further comprising a transmitter coupled to the sensor and configured to transmit an output thereof

30. The system according to claim 26, wherein the power source is one of a battery, a fuel cell, a solar cell, an RFID circuit, an inductive generator, a piezoelectric generator, a thermoelectric generator, and a kinetic micro generator.

31. The system according to claim 26, wherein the electrical power source provides power in response to a triggering event.

32. The system according to claim 31, wherein the triggering event comprises an access event.

33. The system according to claim 32, wherein the access event comprises at least one of an opening event, a dispensing event, filling event, closing event, dropping event, picking up event, shaking event, transporting event, holding event, a spillage event, a leakage event and a re-filling event.

34. The system according to claim 26, wherein the power source generates power in response to the triggering event.

35. The system according to claim 26, for a container having a main body and a lid wherein the power source provides power in response to the movement of the lid.

36. The system according to claim 26, for a container having a main body and a lid wherein at least one component is configured for being disposed on an inner surface of a lid of the container.

37. The system according to claim 36, wherein the at least one component comprises at least a component of at least one of the amount sensor, the transmitter and the power source.

38. The system according to claim 26 further comprising a lid removably closing the container, at least one of the amount sensor, the transmitter, and the power source being coupled to the lid.

39. The system according to claim 26, wherein the amount sensor comprises a level sensor capable of measuring an indicator of the height of the substance in the container.

40. The system according to claim 39, wherein the level sensor is disposed at a reference point, and is capable of measuring the distance between the reference point and a surface of the contents of the container.

41. The system according to claim 26, further comprising at least one of:
a data storage medium and at least one element of stored data contained therein; and wherein the transmitter is further configured to transmit the at least one element of stored data with the output;
a data storage medium and at least one element of stored data contained therein; and wherein the transmitter is further configured to transmit the at least one element of stored data with the output;
a second sensor coupled to the transmitter, and wherein the transmitter is configured to transmit an output of the second sensor;
a data storage medium containing at least one characteristic of the container and a processor coupled to the data storage medium and to the sensor and configured to receive an output of the sensor and for determining the amount of substance based on the output and the at least one characteristic;
a common enclosure for the sensor, transmitter, and power source, wherein the common enclosure is removably attached to the container;
a second sensor comprising at least one of a sensor, a gas sensor, a temp sensor, an image sensor, a chemical sensor, a light sensor, and a pressure sensor;
a clock;
a user authorization device;
a user authentication device;
a unidirectional permeable membrane protecting the device from the contents of the container; and
a data storage medium containing at least one characteristic of the container and coupled to the transmitter, the transmitter being configured to transmit the at least one characteristic.

42. A portable container comprising:
a body having a compartment capable of containing an amount of substance;
an opening into the compartment; and
a lid movable relative to the compartment to selectively close the opening, the lid further comprising an amount sensor capable of measuring the amount of substance in the compartment.

43. The container according to claim 42, wherein the amount sensor comprises a height sensor capable of measuring the height of the substance in the compartment.

44. The container according to claim 42, further comprising a transmitter coupled to the sensor and configured to transmit an output thereof.

45. The container according to claim 44, wherein the lid further comprises an identifier wherein the transmitter is further configured to transmit the identifier.

46. The container according to claim 45, wherein the identifier is derived from at least one of:
an attribute of the substance;
an attribute of the container;
an attribute of the manufacturer;
a time;
an attribute of an event associated with the life of the substance;
a non-measurable attribute;
an attribute is stored at one of the times of manufacture of a component;
an attribute stored at the time of assembly of the components;
an attribute stored at the time of the first use of the substance;
an attribute stored at the time of filling of the container with substance; and
a dynamically generated attribute.

47. The container according to claim 42, further comprising a power source powering the sensor and the transmitter.

48. The container according to claim 47, wherein the power source comprises a micro-generator capable of generating power from the movement of the lid.

49. The device according to claim 47, wherein the body has a first surface, the lid comprises a second surface, and the power source comprises a generator including a source of magnetic flux distributed radially on one of the first and second surfaces and a flux responsive device extended radially on the other of the first and second surfaces.

50. The device according to claim 47, wherein the source of magnetic flux comprises at least one permanent magnet and the flux responsive device comprises a conductive coil.
